(19) United States
(12) Patent Application Publication
(10) Pub. No.: US 2005/0207501 A1
(43) Pub. Date: Sep. 22, 2005

(54) Method of and system for video bit allocation for scene cuts and scene changes

(75) Inventor: Cheung Auyeung, Sunnyvale, CA (US)

Correspondence Address: Jonathan O. Owens;HAVERSTOCK & OWENS LLP, 162 North Wolfe Road, Sunnyvale, CA, 94086, US

(73) Assignees: Sony Corporation; Sony Electronics Inc.

(21) Appl. No.: 10/943,295

(22) Filed: Sep. 17, 2004

Related U.S. Application Data
(60) Provisional application No. 60/554,531, filed on Mar. 18, 2004.

(51) Int. Cl. H04N 11/04

(52) U.S. Cl. 375/240.26

(57) ABSTRACT

A method of and system for encoding a sequence of pictures without overflowing or underflowing a decoder buffer is disclosed. In one embodiment, the method uses a single-pass algorithm to store picture data that has been encoded using an MPEG standard. The method is used to monitor a characteristic of a macroblock, such as the type of picture encoded within the macroblock (e.g., I-picture, B-picture, and P-picture). A storage parameter based on the type of picture is dynamically generated and used to store the macroblock. Storage parameters include any combination of bits allocation, quantization step, or other parameters that ensure that the decoder buffer neither overflows nor underflows. Storage parameters are determined for the current picture, on-the-fly, and are thus optimized. A decoder buffer is well suited for providing smooth pictures during scene cuts and scene changes.

### RELATED APPLICATION

This application claims priority under 35 U.S.C. § 119(e) of the co-pending U.S. provisional patent application Ser. No. 60/554,531, filed on Mar. 18, 2004, and titled “A VIDEO BIT ALLOCATION ALGORITHM FOR SCENE CUTS AND SCENE CHANGES.” The provisional patent application Ser. No. 60/554,531, filed on Mar. 18, 2004, and titled “A VIDEO BIT ALLOCATION ALGORITHM FOR SCENE CUTS AND SCENE CHANGES,” is hereby incorporated by reference.

### FIELD OF THE INVENTION

This invention relates to video encoding and decoding systems. More specifically, this invention relates to systems for and methods of allocating bits to video buffers to ensure smooth picture quality at scene cuts and scene changes.

### BACKGROUND OF THE INVENTION

Before being efficiently transmitted over a channel or stored in memory, video data must be compressed to conserve both bandwidth and memory. Video compression can be performed according to many standards, including one or more standards for audio and video compression from the Moving Picture Experts Group (MPEG), such as MPEG-1, MPEG-2, and MPEG-4. Under the MPEG standards, video data is first encoded (e.g., compressed) and then stored in an encoder buffer on an encoder side of a video system. Later, the encoded data is transmitted to a decoder side of the video system, where it is stored in a decoder buffer, before being decoded so that the corresponding pictures can be viewed.

Video compression according to an MPEG standard uses intra-coded (I) pictures; bi-directionally coded (B) pictures; and predicted coded (P) pictures. I-pictures contain all the information needed to reconstruct a picture. Both B-pictures and P-pictures, on the other hand, use information from previous pictures, subsequent pictures, or both to reconstruct a picture. In this way, B-pictures and P-pictures require fewer bits to store picture data, generally containing difference bits for the difference between the current picture and a previous picture, subsequent picture, or both. B-pictures and P-pictures are thus used to reduce redundant information contained across pictures. In operation, a decoder receives a B-picture or P-picture encoded by an encoder and uses a previous or subsequent picture to reconstruct the original picture. This process is much easier and produces smoother scene transitions when sequential pictures are substantially similar, since the difference in the pictures is small.

Problems can occur during a scene cut or scene change. A scene cut occurs when pictures (e.g., scenes) with substantially different content are immediately (e.g., abruptly) displayed. A scene change occurs, for example, when sequential pictures contain content that change gradually over time, such as when a camera is panned. In either case, because the current picture now contains new content, the difference between previous pictures and the current picture are large and noticeable. Using current algorithms to reconstruct a scene after a cut or change, the change between pictures is choppy and noticeable to a viewer.

FIG. 1 is used to illustrate the choppiness inherent in prior art systems during a scene change or scene cut. FIG. 1 illustrates a coordinate axis system 100 containing three graphs 105, 110, and 115, each plotting a statistic, on a vertical axis 103, versus a picture frame number on a horizontal axis 102. The graphs 105, 110, and 115 were generated using a prior art system for encoding a sequence of pictures. The frame numbers correspond to a 2,482 frame sequence produced by concatenating ten MPEG4 standard test sequences, as shown on a horizontal axis 102. As used herein, the words “picture” and “frame” are used interchangeably. The graph 105 plots a signal-to-noise ratio snr_Y(dB) versus frames. The graph 115 plots the percentage of intra-macroblocks per frame divided by 10. The graph 110 plots the percentage of HRD fullness divided by 10. For simplicity, as used herein, HRD refers not only to the MPEG-4 part 10 Hypothetical Reference Decoder (HRD) Specification but also to the MPEG1 Video Buffering Verifier (VBV), the MPEG2 VBV, MPEG4 part 2 VBV.

The graphs 105, 110, and 115 all illustrate statistics generated using a conventional buffer regulation method similar to Test Model 5 (TM-5) in an H.264 encoder. The method is a slightly modified TM-5 rate control, modified to disregard the last stage adjustment of the quantization stage, which is well known to those skilled in the art. As shown in FIG. 1, the conventional buffer regulation scheme maintains the value of (percentage HRD fullness)/10 between 0 and 10 (line 110 at section 180). However, when a scene cut occurs, as shown around frame 1600, the (percentage of intra macroblock per frame)/110 is approximately 10 (line 115), the PSNR (line 105) drops precipitously (the circled portion 107) and recovers slowly. This slow recovery of picture quality after a scene cut is visible and annoying to a viewer, especially when the recovery time lasts more than one-quarter of a second.

Some prior art systems attempt to smooth transitions between scenes by tracking long-term or slowly varying average statistics to determine a quantization step size, methods addressed to gradual scene changes. These prior art systems do not address scene cuts or scene changes. Moreover, average statistics are ill-suited for scene cuts or changes. Other prior art systems use a multiple-pass rate-control algorithm. Multiple-pass rate-control systems encode a picture several times and then choose the encoded picture that achieves the best balance between picture quality and compression. These multiple-pass rate-control algorithms allocate a pre-determined number of bits for the decoder buffer.

Multiple-pass rate control algorithms suffer several disadvantages. First, they are slower, requiring that a single picture be processed multiple times. Their speed thus makes them ill-suited for systems that require fast processing, such as applications used in real-time video. Second, unless the encoder has some look-ahead capability to evaluate the current or subsequent pictures, the allocated frame memory may be too large or small. If the allocated frame memory is too small, the number of bits encoded may not be sufficient to reconstruct an accurate picture. If the allocated memory is too large, the large delay in storing and transmitting the bits makes it unsuitable for encoding and decoding live video.

### SUMMARY OF THE INVENTION

In a digital video system that uses compression or other encoding techniques to efficiently store data, a system and method ensure smooth pictures of scene changes or scene cuts. The system and method ensure this by preventing decoder buffer overflows and underflows. The system and method achieve this by monitoring a portion of the data corresponding to the picture, such as a macroblock, and adjusting storage parameters for storing the picture data to prevent buffer overflow and buffer overflow. The method and corresponding system use a single-pass algorithm. Alternatively, a multi-pass algorithm is used.

In a first aspect, a method of storing picture data corresponding to a first picture and having a plurality of portions comprises monitoring a characteristic of one portion of the picture data; dynamically generating a storage parameter based on the characteristic; and storing at least one of the portions based on the storage parameter. In one embodiment, the storage parameter corresponds to the number of bits to encode the portion. Alternatively, the storage parameter corresponds to a size of a buffer and storing at least one of the portions comprises allocating a buffer with that size. In one embodiment, each portion comprises a macroblock containing a corresponding portion of the picture data.

In another embodiment, each portion of the picture data corresponds to data compressed according to a compression standard. The characteristic corresponds to a type of the first picture. The type is one of an intra-coded picture, a bi-directionally coded picture, and a predicted-coded picture. The compression standard is an MPEG standard. Alternatively, the compression standard is one of H.261, H.264, and VC1, a Society of Motion Picture and Television Engineers (SMPTE) standard. In another embodiment, the characteristic is a quantization step size.

In another embodiment, the method further comprises allocating a buffer having an initialization size. The plurality of pictures together form a group of pictures. The method further comprises storing the plurality of the portions in one or more buffers, whereby the one or more buffers do not overflow or underflow. Also monitoring, generating, and storing together are part of a single-pass algorithm.

In another embodiment, the storage parameter is also based on a characteristic corresponding to one or more previous pictures. The characteristic corresponds to an average buffer fullness, a sum of bits used for storing the portions of picture data, a sum of the bits allocated for storing the portions of picture data, a count of the portions of picture data, or any combination of these. In another embodiment, storing the plurality of portions occurs at a variable rate.

In another embodiment, the method further comprises decoding the plurality of stored portions to recover a second plurality of portions corresponding to a second picture. The method further comprises transmitting the second plurality of portions at a variable rate.

In a second aspect, a system for storing picture data having a plurality of portions and corresponding to a first picture comprises a storage controller coupled to a memory. The storage controller contains a first set of computer instructions that instruct the storage controller to monitor a current characteristic of a portion of the picture data, to dynamically generate a storage parameter based on the current characteristic, and to store at least one of the portions based on the storage parameter. The memory stores the at least one of the portions.

In a third aspect, a system for storing picture data having a plurality of portions comprises a first storage controller containing a first set of computer instructions that instruct the first storage controller to monitor a current characteristic of a portion of the picture data, dynamically generate a storage parameter based on the current characteristic, and store at least one of the portions based on the storage parameter; a first memory buffer coupled to the storage controller for storing the at least one of the portions; a communications channel coupled to the first memory buffer; a second memory buffer coupled to the communications channel; and a second storage controller coupled to the second memory buffer.

### BRIEF DESCRIPTION OF THE DRAWINGS

FIG. 1 is a graph of frame statistics for a plurality of frames, using a conventional dynamic bit allocator.

FIG. 2 is a schematic of a video system including a dynamic bit allocator.

FIG. 3 is a flow chart of steps for storing a video picture, ensuring that a buffer does not overflow or underflow.

FIG. 4 is a graph representing buffer fullness versus time for a decoder buffer controlled by a rate controller.

FIGS. 5A-C together depict a flow chart for allocating bits.

FIG. 6 is a graph of frame statistics for the plurality of frames shown in FIG. 1, using a dynamic bit allocator.

### DETAILED DESCRIPTION OF THE INVENTION

A system and method for storing picture data ensures smooth transitions during scene cuts and scene changes. The method initially allocates a range of bits to picture data that represents a picture in a sequence of pictures. Later, during storage, a rate control algorithm dynamically readjusts storage parameters for storing the picture data. In embodiments, the storage parameters include, but are not limited to, any combination of memory size and quantization step size. The memory size is reallocated based on a characteristic of the portion of picture data. When a portion of picture data corresponds to a macroblock, for example, the memory for the macroblock is re-allocated based on the type of the picture, whether it be an I-picture, a B-picture, or a P-picture. Alternatively, the memory is re-allocated based on the number of discrete cosine transform (DCT) coefficients used to encode the picture data contained in a macroblock. It will be appreciated that the storage parameters can be adjusted based on characteristics other than or in addition to the content of the current picture.

The method is able to make adjustments on the fly. The method need not immediately know whether a picture contains all intra-coded macroblocks and thus requires more memory to store the encoded picture data in the macroblocks. The method first allocates a decoder buffer and then reallocates (e.g., resizes) the buffer depending on the type of macroblock. Thus, unlike prior art systems, the bit rate and frame rate are varied to optimally store picture data to prevent buffer overflow and underflow. The storage parameters are adjusted so that a memory size matches statistics of the changes in a sequence of pictures. Embodiments use a single-pass algorithm to store picture data and do not require look-ahead capabilities. It will be appreciated, however, that other embodiments alternatively use a multiple-pass algorithm.

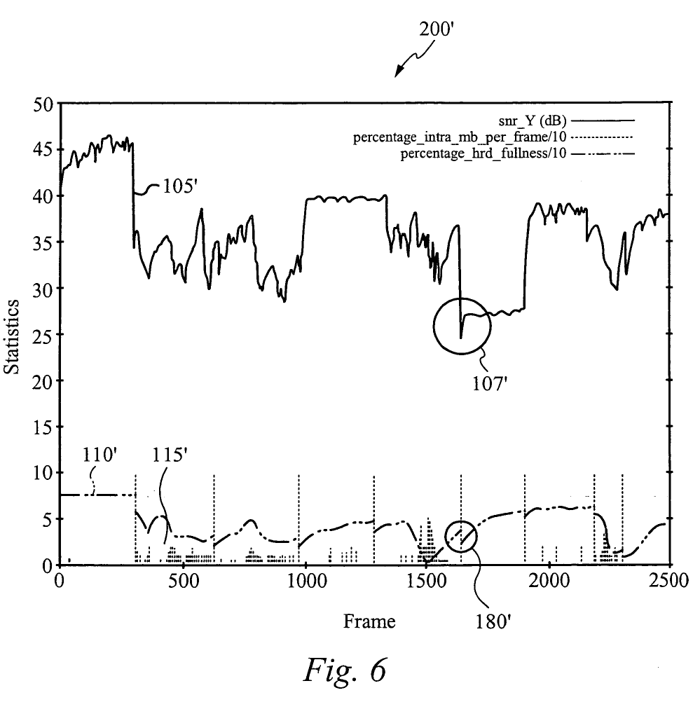

The discussion that follows describes embodiments of a decoder buffer. For example, FIG. 6 is a graph depicting statistics for a decoder buffer. It will be appreciated that in many applications, characteristics of the decoder buffer reflect those of a corresponding encoder buffer for the same video system. For example, in accordance with one embodiment, the sum of the bits in an encoder buffer and in the decoder buffer remains substantially constant during the processing of video data. Thus, any description for receiving, storing, and decoding data in a decoder applies equally to encoding, storing and transmitting data from an encoder.

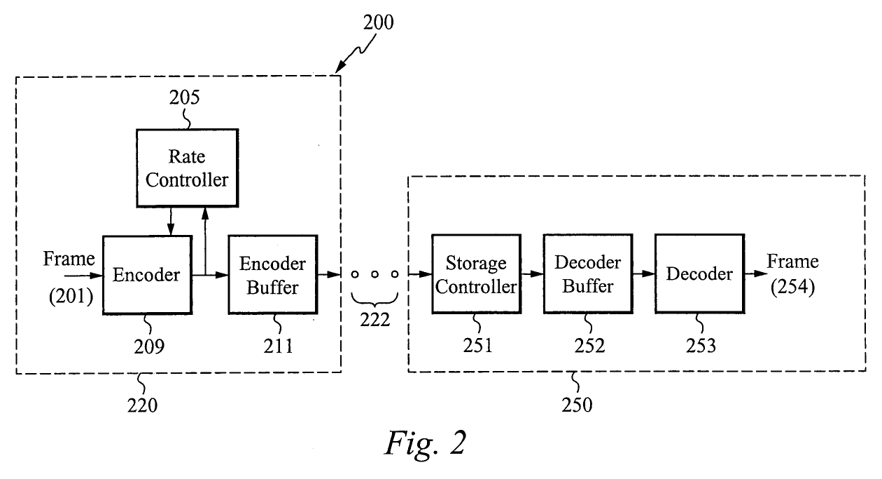

FIG. 2 illustrates a video codec system 200. The video codec system 200 comprises a video coder system 220 coupled to a video decoder system 250 over a channel 222. The encoder system 220 comprises an encoder 209 coupled to a rate controller 205 and an encoder buffer 211. The decoder system 250 comprises a storage controller 251 (e.g., a dynamic rate allocator) coupled to a decoder buffer 252, which is in turn coupled to a decoder 253. In operation, one or more picture frames 201 represented as video data (e.g., bits) are transmitted to an encoder 209, which encodes the bits and stores the encoded bits in an encoder buffer 211. The rate controller 205 controls the rate at which the encoded bits are stored in the encoder buffer 211. The bits are encoded according to an MPEG, ITU, or SMPTE standard, such as MPEG-1, MPEG-2, MPEG-4, H.264, and VC1. Under any of the MPEG standards, the bits are compressed to conserve bandwidth when the bits are transmitted over the channel 222 or to conserve memory when the bits are stored, for example, on a digital video disk (DVD) or other storage device. It will be appreciated that the bits can be encoded using other standards such as H.261, H.263, H.264, and VC1. The channel is any number of channels including, but not limited to, a local area network, a wide area network, a wireless network, or a direct connection such as between components in a digital video disk player. When the encoded bits are received at the storage controller 251, the encoded bits are stored in the decoder buffer 252.

After the picture data are stored in the decoder buffer 252, they are transmitted to the decoder 253, which is used to recover the frame 254 corresponding to the frame 201. If the system 200 is lossless, the frame 254 is identical to the frame 201.

It will be appreciated that both the encoder system 220 and the decoder system 250 have other configurations. For example, in one embodiment the encoder system 200 has a storage controller (e.g. rate controller) coupled to the encoder. This storage controller functions similar to the storage controller 251, controlling storage of video data in the encoder buffer 211.

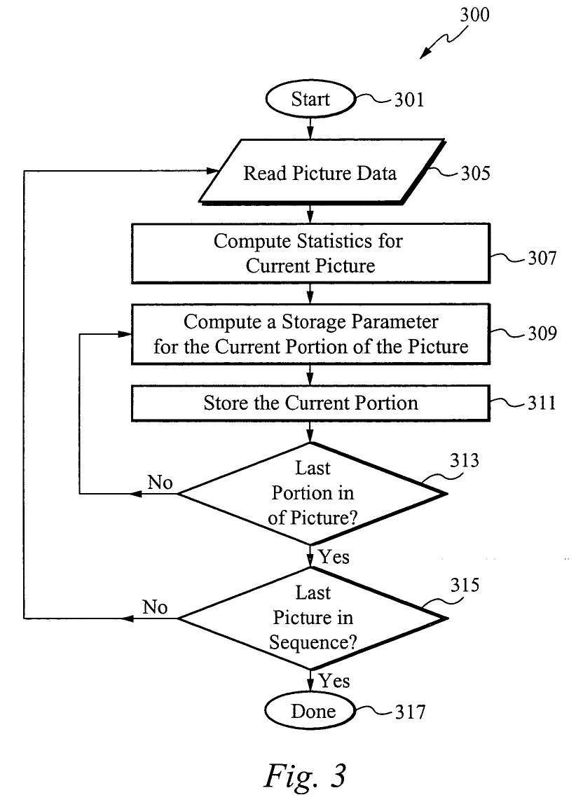

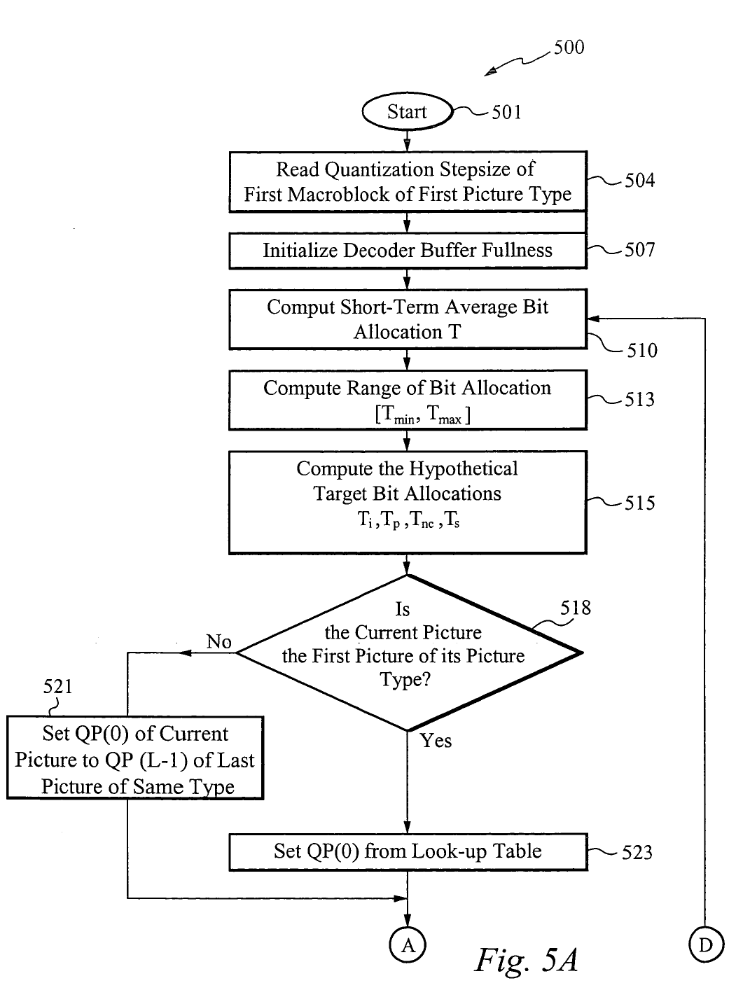

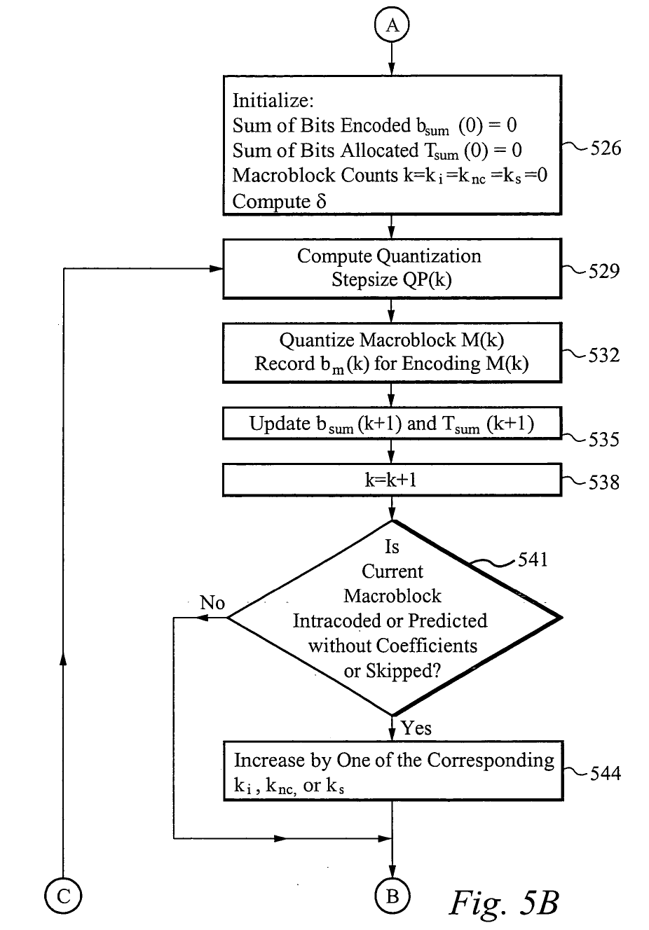

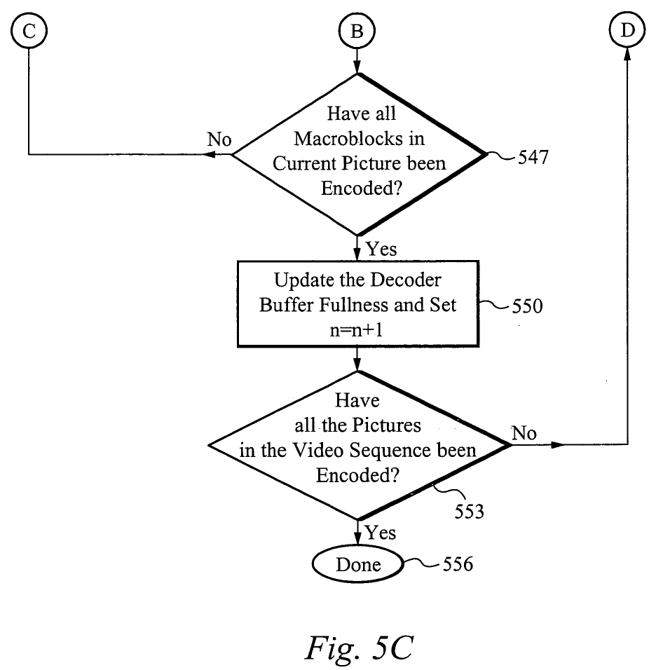

FIG. 3 is a high-level flow chart 300 of a method for storing a sequence of pictures. A more detailed flow chart is shown in FIGS. 5A-C below. Referring to FIG. 3, in the start step 301, computation parameters are initialized. For example, parameters such as a quantization step size, the number of portions of a picture already processed, and other parameters are initialized in this step 301. Next, in the step 305, picture data are read. Preferably, the data are bits that are used to represent and later reconstruct a picture. In the step 307, statistics for the current picture are computed, and in the step 309, the statistics are used to compute a parameter used to store the portion of the picture. Thus a storage parameter is adjusted while storing the current picture, thus allowing the storage parameters to be optimized on the fly, to optimally store the picture currently being processed.

Next, in the step 311, the portion of the picture is stored. In the step 313, it is determined whether the last portion of the picture has been stored. If the last portion has been stored, processing continues to the step 315; otherwise, processing goes back to the step 309.

In the step 315, it is determined whether the last picture in the sequence was stored. If the last picture was stored, processing continues to the step 317, where processing completes. Otherwise, processing returns to the step 305.

As described above, the system and method for storing picture data are used to store (i.e., allocate memory for) pictures of any type. The first frame of a sequence of pictures is encoded as an I-frame. Subsequent frames are coded as P-frames at a fixed bit rate and a fixed frame rate using the Video Buffering Verifier (VBV) model of MPEG2.

The decoder model, such as the VBV, governs how the rate control of the encoder should control the encoding process. It serves as the fundamental requirement of any rate controller. The premise of the decoder model is that the decoder has a decoder buffer that is initially empty. The encoded bit stream enters the decoder buffer according to an arrival schedule and is removed according to a removal schedule. According to the removal schedule, the earliest arrived compressed picture is simultaneously removed from the decoder buffer and instantaneously decoded by the decoder to produce a decoded picture. For fixed bit rate and fixed frame rate progressive video, the bit stream arrives at the decoder buffer at a given fixed bit rate. After an initial delay of the first arrived bit, it is removed from the decoder buffer at the given frame rate. The system and method for storing picture data ensures that the encoded bit stream does not cause the decoder buffer to overflow or underflow.

As described below, for the rate control of the encoder to control the decoder buffer fullness, the rate control must monitor the decoder buffer fullness. For video to be encoded at a fixed frame rate f and a fixed bit rate R, two factors completely determine the buffer fullness. These two factors are the initial delay of the first arrived bit dₐᵢ and the amount of bits b(n) for encoding the picture n, for all n.

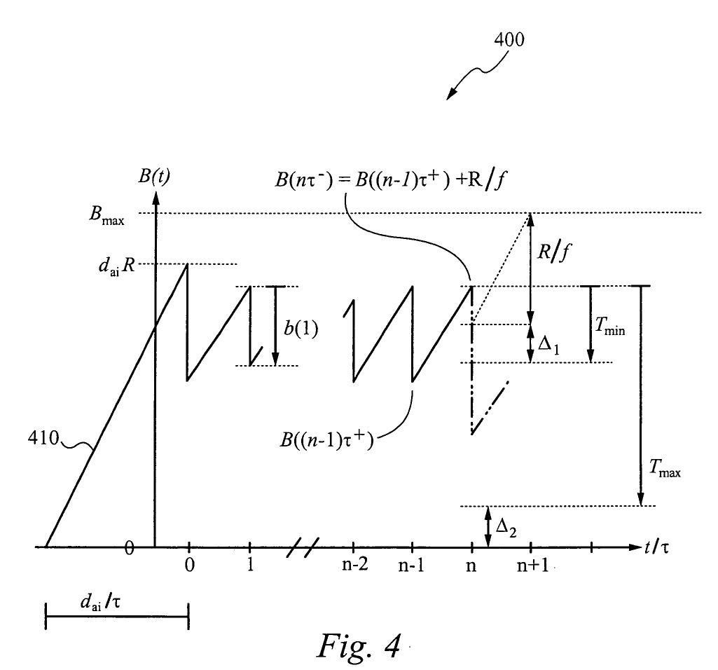

As shown in FIG. 4, B(t⁻) and B(t⁺) are the decoder buffer fullness just before and after time t, respectively. For purposes of this explanation, the first bit of the bit stream arrives at time −dₐᵢ, so that the first frame is decoded at time t=0. In other words, the decoder buffer is pre-filled so that its buffer fullness at time 0, just before decoding at time 0 shown in FIG. 4, is given by equation 1:
B(0⁻)=dₐᵢR [Equation 1]

FIG. 4 further shows that each line segment that together form the line 410 is one having either a positive slope or a vertical slope. Each line segment with a positive slope reflects the decoder buffer filling with picture data bits. Each line segment with a vertical slope reflects the decoder buffer being emptied of data. That is, data is removed from the decoder buffer so that it is decoded to recover picture data and then combined with other picture data to reconstruct a sequence of pictures.

Still referring to FIG. 4, assuming τ=1/f is the frame period and n is a non-negative integer, at time nτ, the nth coded picture with b(n) coded bits is simultaneously removed from the decoder buffer and simultaneously decoded by the decoder. The decoder buffer fullness is given by equation 2:
B(nτ⁺)=B(nτ⁻)−b(n) [Equation 2]

The decoder buffer is being filled up by the arriving bit stream at the constant rate R, so that after one frame period, the decoder buffer fullness is given by Equation 3:
B((n+1)τ⁻)=B(nτ⁺)+R/f [Equation 3]

To avoid the decoder buffer overflow and underflow, Equation 4 must be satisfied for all times t during decoding:
0<B(t)≦Bₘₐₓ [Equation 4]
Here, Bₘₐₓ is the decoder buffer size.

If there is no decoder buffer overflow, combining Equations (2), (3), and (4) results in Equation (5):
B((n+1)τ⁻)=B(nτ⁺)+R/f=B(nτ⁻)−b(n)+R/f≦Bₘₐₓ [Equation 5]

By rearranging Equation (5), Equation (6) is derived:
b(n)≧B(nτ⁻)+R/f−Bₘₐₓ [Equation 6]
If there is no decoder buffer underflow, Equation (7) follows:
0≦B(nτ⁺)=B(nτ⁻)−b(n) [Equation 7]
From Equation (7), Equation (8) is derived:
b(n)≦B(nτ⁻) [Equation 8]
Combining Equations (6) and (8), Equation (9) is derived:
B(nτ⁻)+R/f−Bₘₐₓ≦b(n)≦B(nτ⁻) [Equation 9]

The rate control has two purposes. The first purpose is to control the number of bits b(n) of each frame so that Equation (4) holds for all times for a predetermined buffer fullness B(0⁻). The second purpose is to maximize the visual video quality. Thus, bits are allocated to a picture to increase the probability of satisfying Equation (4) and to provide stable picture quality transition at a scene cut, a scene change, or both.

Unlike conventional methods such as TM5, the system and method for storing picture data provide stable picture quality transition at a scene cut, a scene change, or both by allocating a target range of bits [Tₘᵢₙ, Tₘₐₓ] to the current picture n. In this way, the total bit usage for encoding the picture n matches the complexity of each macroblock within the picture. To satisfy Equation (4), any bit amount within the range [Tₘᵢₙ, Tₘₐₓ] should not overflow or underflow the decoder buffer. Therefore, from Equation (9) follows Equation (10):
B(nτ⁻)+R/f−Bₘₐₓ≦Tₘᵢₙ≦Tₘₐₓ≦B(nτ⁻) [Equation 10]
For encoding progressive video at a fixed bit rate and a fixed frame rate by the H.264 baseline encoder, where the first frame is encoded as an I frame and subsequent frames as P frames, the short term average target bit allocation is given by Equation (11):
T=αR/f [Equation 11]
HERE, α>0 is a feedback parameter that regulates the short term average decoder buffer fullness. In general, when the decoder buffer becomes full, α is set greater than 1 to decrease the short term average buffer fullness. When the decoder becomes empty, α is set<1 to increase the short term average buffer fullness. In this embodiment, α is set according to Equation (12):
α=(βₘᵢₙ+(100−βₘᵢₙ)B(nτ⁻)/B_{target})/100 [Equation 12]
In Equation (12), βₘᵢₙ>0 is the minimal value of the feedback parameter α. In one embodiment, α is independent of the decoder buffer size.

Those skilled in the art will recognize that the H.264 baseline is generally used for video conferencing and other real-time applications. In contrast, the H.264 main is generally used for digital video disks (DVDs) and entertainment video systems. The system and method for storing picture data are suited to H.264 applications, MPEG applications, and any other applications that compress and later decompress video data.

In this embodiment, when the decoder buffer is empty, T=βₘᵢₙR/(100f). The parameter B_{target} is the target decoder buffer fullness that the rate controller is intended to maintain. In one embodiment, βₘᵢₙ=50 and β_{target}=0.85Bₘₐₓ. It will be appreciated that these values for Bₘᵢₙ β_{target}, and Bₘₐₓ are chosen for simplicity, and that other values for each can be used.

The range [Tₘᵢₙ, Tₘₐₓ] is determined in many ways. In accordance with one embodiment, the endpoints Tₘᵢₙ and Tₘₐₓ are determined according to Equations (13a) and (13b), collectively referred to as Equation (13), for positive valued Δ₁ and Δ₂:
Tₘᵢₙ=B(nτ⁻)+R/f−Bₘₐₓ+Δ₁ [Equation 13a]
Tₘₐₓ=B(nτ⁻)−Δ₂ [Equation 13b]
Here, Δ₁ and Δ₂ are positive padding used to ensure that Equation (10) is satisfied. In one embodiment, Δ₁=Δ₂=R/(10f).

After the target bit range [Tₘᵢₙ, Tₘₐₓ,] is allocated to the current picture, the implementation regulates the number of bits encoded for the current picture by adjusting the quantization step size of each macroblock, one at a time. For example, if each picture has L macroblocks then M(k) is the k^{th} macroblock and QP(k) is its associated quantization step size in the encoding order.

QP(0) is determined in many ways. In one example, QP(0) is determined using statistics such as an average quantization step size for a particular picture type. In this embodiment, QP(0) of the first coded picture of a given type is obtained from a pre-determined lookup table for that picture type. Thus, each picture type (I-frame, B-frame, and P-frame) has a corresponding lookup table. For another picture of the same type, QP(0) equals the Q(L−1) of the last macroblock of the last picture with the same picture type in encoding order. The quantization step size of the macroblock M(k) is given by Equation (14):
QP(k)=QP(0)+(bₛᵤₘ(k)−tₛᵤₘ(k))/δ [Equation 14]
Here, bₛᵤₘ(k) is the sum of the bits encoded by the previous macroblocks M(0), M(1) . . . M(k−1), and tₛᵤₘ(k) is the sum of the bits allocated to the corresponding macroblocks. The parameter δ, defined below, is a parameter that controls how fast the quantization step size should respond to the changes on the decoder buffer fullness. In general, δ adjusts the quantization step size to change faster when the decoder buffer fullness is close to either overflowing or underflowing.

The sum of the bits for encoding the previous macroblock bₛᵤₘ is given by Equation (15):

$${b}_{sum} ( k ) = \{ \begin{matrix}0 , if k = 0 \\ {b}_{sum} ( k - 1 ) + {b}_{m} ( k - 1 ) , if 0 < k \leq L\end{matrix} \qquad [ Equation 15 ]$$

Here, bₘ(k−1) is the number of bits encoded by the macroblock M(k-1).

The sum of the bits allocated to the macroblocks M(0), M(1), . . . , M(k−1) equals tₛᵤₘ(k). This embodiment assumes that the macroblocks in the current picture are only (1) intra-coded, (2) predicted with coded transform coefficients, (3) predicted without coded transform coefficients, or (4) skipped.

In one embodiment, Tᵢ is the bit allocation when all the macroblocks are intra-coded. Tₚ is the bit allocation when all the macroblocks are predicted and coded with transform coefficients. T_{nc} is the bit allocation when all the macroblocks are predicted but not coded with transform coefficients. And Tₛ is the bit allocation when all the macroblocks are skipped. In this embodiment, Equation (16) holds:

$${T}_{x} ( k ) = \{ \begin{matrix}{T}_{min} , if {α}_{x} T < {T}_{min} \\ {T}_{max} , if {α}_{x} T > {T}_{max} \\ {α}_{x} T , otherwise\end{matrix} \qquad [ Equation 16 ]$$

where x∈{i, p, nc, s} and Tₓ(k) is the bit allocation for an entire picture. Here, the value αₓ is used to compensate for the different macroblock types. For example, if the current picture is an I picture, then Equation (17) holds:
αᵢ=αₚ=α_{c}=α_{c}=4 [Equation 17]
If the current picture is a P picture, then Equation (18) holds:
αᵢ=3
αₚ=1
α_{nc}= 7/8
αₛ= 1/8 [Equation 18]
It will be appreciated that other values for αᵢ, αₚ, α_{nc}, and αₛ can be chosen. In one embodiment, only αᵢ and αₚ are used; α_{nc} and αₛ are either ignored or set to 0.

To define tₛᵤₘ(k), kᵢ is the number of an intra macroblock, k_{nc} is the number of macroblocks with no coded DCT coefficients in the compressed bit stream, and kₛ is the number of skipped macroblocks (e.g., no motion vector or DCT coefficients), among the previously coded macroblocks {M(0), M(1), . . . M(k−1)}. In this case, Equation (19) holds:
tₛᵤₘ(k)=((k−kᵢ−k_{nc}−kₛ)Tₚ+kᵢTᵢ+k_{nc}T_{nc}+kₛTₛ)/L [Equation 19]
In accordance with Equation 19, if a macroblock is an intra macroblock, Tᵢ/L bits are allocated to it. Similarly, if the macroblock is a predicted macroblock with coded coefficients, it is allocated Tₚ/L bits; if it is a predicted macroblock without coefficients, it is allocated T_{nc}/L bits; and if it is a skipped macroblock, it is allocated Tₛ/L bits. Here, L equals the number of macroblocks in a picture.

To determine the quantization step size, Equation (14) (repeated here as Equation (20)) is again used:
QP(k)=QP(0)+(bₛᵤₘ(k)−tₛᵤₘ(k))/δ [Equation 20]
The parameter δ must be determined. The parameter δ is used to regulate how fast the quantization step size changes in response to the differential decoder buffer fullness bₛᵤₘ(k)−tₛᵤₘ(k). The parameter δ is thus used to compensate for the difference between the target bit size and the bit size actually allocated.

The parameter δ is normally determined before encoding any macroblock within the current picture. To determine δ, the intermediate variables δ_{p, min}, δp, max, δ_{i, min}, δi, max are defined in Equations (21) and (22) as follows:
δ_{p, min}=(Tₚ−Tₘᵢₙ)/(QPₘₐₓ−QP(0)+1)
δ_{p, max}=(Tₘₐₓ−Tₚ)/(QP(0)−QPₘᵢₙ+1) [Equation 21]
δ_{i, min}=(Tᵢ−Tₘₐₓ)/(QPₘₐₓ−QP(0)+1)
δ_{i, max}=(Tₘₐₓ−Tᵢ)/(QP(0)−QPₘᵢₙ+1) [Equation 22]
Here, QPₘₐₓ and QPₘᵢₙ are, respectively, the largest and smallest quantization step size supported by the encoder. In one embodiment for an H.264 encoder, QPₘₐₓ=51 and QPₘᵢₙ₌0. It will be appreciated that other values are used for QPₘₐₓ and Qₚₘᵢₙ based on other parameters such as the encoding (e.g., compression) algorithm and the hardware limitations.

In one embodiment, other intermediate variables are defined:
δₙₒᵣₘₐₗ=(α_{qp}R/f)/(QPₘₐₓ−QPₘᵢₙ)
δₘᵢₙ=δₙₒᵣₘₐₗ/8 [Equation 23]
where α_{qp} depends on the picture type of the current picture. Again, values can vary among the different encoders and can vary even for the same encoder. For example, in one embodiment for an H.264 encoder, α_{qp}=12 for an I-picture and α_{qp}=3 for a P-picture.

Finally,
δ=max(δₘᵢₙ, min(δ_{normal, δ}_{p, min}, δp, max, δ_{i, min}, δi, max)). [Equation 24]
After QP(k) is computed as in Equation (20), it is clipped so that QPₘᵢₙ≦QP(k)≦QPₘₐₓ, and the clipped QP(k) is used to encode the macroblock M(k).

FIG. 5 illustrates the steps 500 of a method for preventing buffer overflow and underflow in an encoder buffer and thus also in a decoder buffer. Because a decoder system and encoder system function together to prevent overflow and underflow in both an encoder buffer and a decoder buffer, the methods described herein apply to both an encoder buffer and a decoder buffer. In other words, by preventing an encoder buffer from overflowing and underflowing, a decoder buffer is also prevented from overflowing and underflowing. Referring to FIG. 5, after the start step 501, in the step 504, the quantization step size of the first macroblock of the first picture of a picture type is read from a lookup table. In the step 507, the initial decoder buffer fullness B(0⁻) is set to 85*Bₘₐₓ/100. In the step 510, the short-term average bit allocation T is computed using Equations (11) and (12), and in the step 513, the range of the bit allocation [Tₘᵢₙ, Tₘₐₓ] is computed using Equation (13). In the step 515, the hypothetical target bit allocations Tᵢ, Tₚ, T_{nc}, and Tₛ are computed using Equations (16), (17), and (18), based on the short-term average target bit allocation T.

Next, in the step 518, it is determined whether the current picture is the first picture of a given picture type. If so, processing continues to the step 523; otherwise, processing continues to the step 521. In the step 521, QP(0) of the current picture is set to QP(L−1) of the last picture with the same picture type, and processing continues to the step 526. In the step 523, QP(0) is set from the lookup table as in step 504, and processing continues to the step 526.

In the step 526, the sum of the bits encoded, bₛᵤₘ(0), is set to 0; the sum of the bits allocated, tₛᵤₘ(0), is set to 0; the macroblock counts k, kᵢ, k_{nc}, and kₛ, are all set to 0; and the quantization parameter δ is set using Equations (21), (22), (23), and (24). In the step 529, the quantization step size is determined using Equation (22). In the step 532, the macroblock M(k) is quantized using the quantization step size max(QPₘᵢₙ, min(QP(k), QPₘₐₓ)) and then the number of bits bₘ(k) for encoding M(k) is recorded.

After the macroblock M(k) has been encoded, in the step 535 the value bₛᵤₘ(k+1) is updated using Equation (17) and the value Tₛᵤₘ(k+1) is updated using equation (21). In the step 538, k is incremented by 1. In the step 541 it is determined whether the current macroblock is intra-coded, predicted with coded coefficients, or predicted without coded coefficients. If the current macroblock is not intra-coded, or predicted without coded coefficients, or skipped, processing continues to the step 547; otherwise, processing continues to the step 544. In the step 544, if the current macroblock is intra-coded, the value kᵢ is incremented by one; if the current macroblock is predicted without coded coefficients, the value k_{nc} is incremented by one; or if the current macroblock is skipped, the value kₛ is incremented by one. After the step 544, the step 547 is performed.

In the step 547, it is determined whether all the macroblocks in the current picture have been encoded. If all the macroblocks in the current picture have not been encoded, processing loops back to the step 529; otherwise, processing continues to the step 550.

In the step 550, the decoder buffer fullness B((n+1)τ⁻) is updated using Equation (5), and the frame index n is incremented by one to encode the next picture. Next, in the step 553, it is determined whether all the pictures in the video sequence have been encoded. If they have, then processing completes in the step 556. Otherwise, processing loops back to the step 510.

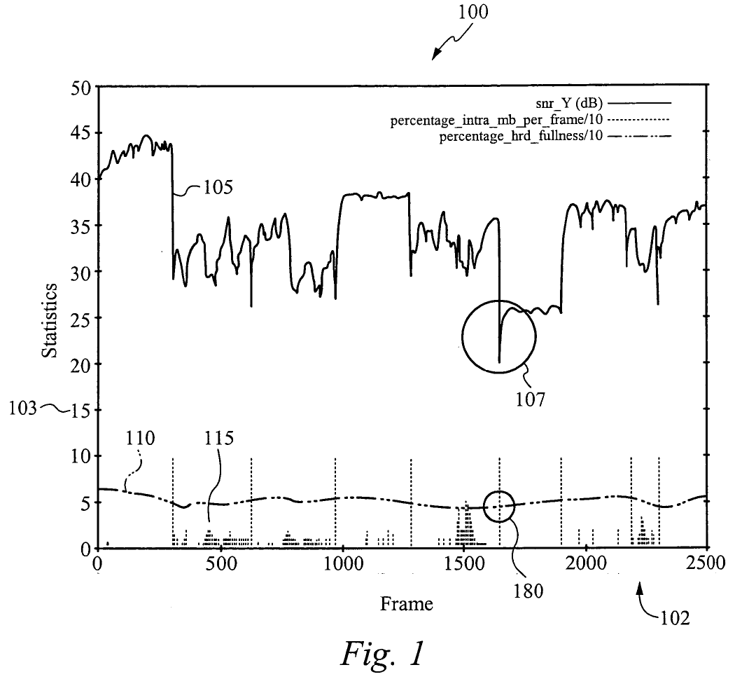

FIG. 6 is a graph illustrating statistics corresponding to the statistics shown in FIG. 1, using a method for storing picture data. Elements numbered with a prime correspond to the same numbered un-primed element in FIG. 1. Thus, for example, the signal-to-noise portion labeled 107′ in FIG. 6 corresponds to the signal-to-noise ratio portion labeled 107 in FIG. 1. A comparison of section 180′ in FIG. 6 with the section 180 in FIG. 1 illustrates that the method for storing picture data described herein reduces the HRD fullness at a scene cut, corresponding to the section 107′ of line 105′. This reduction in HRD fullness advantageously results in smoother transitions and better picture quality at scene cuts.

It will be readily apparent to one skilled in the art that other various modifications may be made to the embodiments without departing from the spirit and scope of the invention as defined by the appended claims. For example, it will be appreciated that while the above embodiments have been described in reference to the MPEG standard, other embodiments also include processing video data according to other video processing standards.

1. A method of storing picture data corresponding to a first picture and having a plurality of portions, the method comprising:
a. monitoring a characteristic of one portion of the picture data;
b. dynamically generating a storage parameter based on the characteristic; and
c. storing at least one of the portions based on the storage parameter.

2. The method of claim 1, wherein the storage parameter corresponds to the number of bits to encode the portion.

3. The method of claim 1, wherein the storage parameter corresponds to a size of a buffer and storing at least one of the portions comprises allocating a buffer with the size.

4. The method of claim 1, wherein each portion comprises a macroblock containing a corresponding portion of the picture data.

5. The method of claim 4, wherein each portion of the picture data corresponds to data compressed according to a compression standard.

6. The method of claim 5, wherein the characteristic corresponds to a type of the first picture, the type one of an intra-coded picture, a bi-directionally coded picture, and a predicted-coded picture.

7. The method of claim 6, wherein the compression standard is an MPEG standard.

8. The method of claim 7, wherein the compression standard is one of H.261, H.264, and VC1.

9. The method of claim 6, wherein the characteristic is a quantization step size.

10. The method of claim 1, further comprising allocating a buffer having an initialization size.

11. The method of claim 4, wherein the plurality of pictures together form a group of pictures.

12. The method of claim 3, further comprising storing the plurality of the portions in one or more buffers, whereby the one or more buffers do not overflow or underflow.

13. The method of claim 1, wherein monitoring, dynamically generating, and storing together are part of a single-pass encoding algorithm.

14. The method of claim 1, wherein the storage parameter is also based on a characteristic corresponding to one or more previous pictures.

15. The method of claim 14, wherein the characteristic corresponds to an average buffer fullness.

16. The method of claim 3, wherein the characteristic corresponds to a sum of bits used for storing the portions of picture data.

17. The method of claim 3, wherein the characteristic corresponds to a sum of the bits allocated for storing the portions of picture data.

18. The method of claim 1, wherein the characteristic corresponds to a count of the portions of picture data.

19. The method of claim 1, wherein storing the plurality of portions occurs at a variable rate.

20. The method of claim 11, further comprising decoding the plurality of stored portions to recover a second plurality of portions corresponding to a second picture.

21. The method of claim 20, further comprising transmitting the second plurality of portions at a variable rate.

22. A system for storing picture data having a plurality of portions and corresponding to a first picture, the system comprising:
a. a storage controller containing a first set of computer instructions that instruct the storage controller to monitor a current characteristic of a portion of the picture data, dynamically generate a storage parameter based on the current characteristic, and store at least one of the portions based on the storage parameter; and
b. a memory coupled to the storage controller for storing the at least one of the portions.

23. The system of claim 22, wherein the storage parameter corresponds to the number of bits to encode a portion.

24. The system of claim 22, wherein the storage parameter corresponds to a size of a buffer and storing at least one of the portions comprises allocating a buffer having the size in the memory.

25. The method of claim 23, wherein each portion comprises a macroblock containing a corresponding portion of the picture data.

26. The system of claim 25, wherein the first set of computer instructions is used to recognize a type of picture data.

27. The system of claim 26, wherein the current characteristic corresponds to a type of a picture, the type one of an intra-coded picture, a bi-directionally coded picture, and a predicted-coded picture.

28. The system of claim 26, wherein the current characteristic is a quantization step size.

29. The system of claim 22, wherein the first set of computer instructions use the storage parameters to generate one or more buffer sizes that do not overflow or underflow.

30. The system of claim 22, wherein the first set of computer instructions use a single-pass algorithm that performs the steps of monitoring, generating, and storing.

31. The system of claim 22, wherein the first set of computer instructions generates and stores historical characteristics of multiple pictures and the current characteristic is based on a historical characteristic.

32. The system of claim 31, wherein the historical characteristic corresponds to an average buffer fullness.

33. The system of claim 31, wherein the historical characteristic corresponds to a sum of the bits used for storing the portions of picture data.

34. The system of claim 31, wherein the historical characteristic corresponds to a sum of the bits allocated for storing the portions of picture data.

35. The system of claim 31, wherein the historical characteristic corresponds to a count of the portions of picture data.

36. The system of claim 22, further comprising a decoder coupled to the memory.

37. The system of claim 36, wherein the decoder contains a second set of computer instructions used to decode encoded data.

38. The system of claim 37, wherein the encoded data is compressed data.

39. The system of claim 38, wherein the encoded data is compressed according to an MPEG standard.

40. The system of claim 38, wherein the encoded data is compressed according to one of H.261, H.264, and VC1.

41. A system for storing picture data having a plurality of portions, the system comprising:
a. a first storage controller containing a first set of computer instructions that instruct the first storage controller to monitor a current characteristic of a portion of the picture data, dynamically generate a storage parameter based on the current characteristic, and store at least one of the portions based on the storage parameter;
b. a first memory buffer coupled to the storage controller for storing the at least one of the portions;
c. a communications channel coupled to the first memory buffer;
d. a second memory buffer coupled to the communications channel; and
e. a second storage controller coupled to the second memory buffer.

42. The system of claim 41, wherein the storage parameter corresponds to the number of bits to encode a portion.

43. The system of claim 41, wherein the storage parameter corresponds to a size of a buffer and storing at least one of the portions comprises allocating a buffer having the size in the second memory buffer.

44. The system of claim 41, wherein the first storage controller further contains a first set of computer instructions that instruct the first storage controller to encode the picture data according to an encoding standard.

45. The system of claim 44, wherein the encoding standard is an MPEG standard.

46. The system of claim 44, wherein the encoding standard is one of H.26, H.263, and VC1.

47. The system of claim 44, wherein the second storage controller contains a second set of computer instructions that instruct the second storage controller to decode the picture data according to a decoding standard complementary to the encoding standard.
